(19) United States
(12) Patent Application Publication
(10) Pub. No.: US 2019/0137034 A1
(43) Pub. Date: May 9, 2019

(54) Combined magnetic hanger frame and charger

(71) Applicant: Jiang FAN, HuBei (CN)

(72) Inventor: Jiang FAN, HuBei (CN)

(21) Appl. No.: 16/236,660

(22) Filed: Dec. 31, 2018

(30) Foreign Application Priority Data
Dec. 12, 2018 (CN) 201811515478.2

(51) Int. Cl. F16M 13/06; F21L 4/08; H01F 7/02; H02J 7/02; H02J 7/00; F16M 13/02

(52) U.S. Cl. CPC F16M 13/06; F21L 4/08; F16M 13/02; H02J 7/025; H02J 7/0042; H01F 7/0252

(57) ABSTRACT

A combined magnetic hanger frame and charger, having a frame body, a magnet provided inside the frame body, and a positive pole pin and a negative pole assembly mounted on the frame body; the negative pole assembly has a negative pole contact piece provided at one side of the frame body, and a negative pole electrically conductive ring provided at another side. A negative pole elastic piece is provided between the negative pole contact piece and the negative pole electrically conductive ring. The negative pole contact piece is also connected with a PCB which is connected with the negative pole contact piece. A side of the negative pole electrically conductive ring distal from the negative pole contact piece is provided with first negative pole contact points; the first negative pole contact points are exposed from an outer side of the frame body.

### BACKGROUND OF THE INVENTION

The present invention relates to the technical field of mobile lighting apparatus, and more specifically relates to a combined magnetic hanger frame and charger.

Common mobile lighting apparatus such as torches, bicycle lights, headlights, or other types of mobile lighting devices are usually disposed simply at a corner of a table or stored inside specified storage cases where they should be found and fetched before use even during emergency. Generally, these mobile lighting apparatus are electrically charged by using micro-USB, and setting up the charging equipment is very inconvenient. Also, in existing prior art, a rack provided for fixing the mobile lighting apparatus is usually positioned in places like on the table, and the mobile lighting apparatus is disposed inside a fixation groove of the rack. The mobile lighting apparatus disposed as such creates trouble for taking out from and returning back the mobile lighting apparatus to the rack, and such a rack has only such a single and simple function.

### BRIEF SUMMARY OF THE INVENTION

In view of the aforesaid disadvantages now present in the prior art, the present invention provides a combined magnetic hanger frame and charger which allows convenient charging and quick fetch and placement of mobile lighting apparatus.

The present invention has the following technical solutions to achieve the above objects:

A combined magnetic hanger frame and charger, comprising a frame body; a magnet is provided inside the frame body; a positive pole pin and a negative pole assembly are mounted on the frame body; the negative pole assembly comprises a negative pole contact piece provided at one side of the frame body, and a negative pole electrically conductive ring provided at another side of the frame body distal from the negative pole contact piece; the negative pole contact piece and the negative pole electrically conductive ring are mutually connected.

Further, the negative pole assembly also comprises a negative pole elastic piece provided between the negative pole contact piece and the negative pole electrically conductive ring.

Further, the negative pole contact piece is also connected with a printed circuit board (PCB); the PCB is connected with the negative pole contact piece.

Further, a side of the negative pole electrically conductive ring distal from the negative pole contact piece is provided with first negative pole contact points; the first negative pole contact points are exposed from an outer side of the frame body.

Further, the positive pole pin comprises a first positive pole contact part and a second positive pole contact part elastically connected; the first positive pole contact part is exposed from one side of the frame body; the second positive pole contact part is exposed from another side of the frame body distal from the first positive pole contact part.

Further, an elastic component is provided between the first positive pole contact part and the second positive pole contact part.

Further, the magnet surrounds the positive pole pin; the magnet is fixed inside the frame body by a lower cover.

Further, the frame body has an inverted L shape.

Further, the frame body comprises a mounting panel and a supporting arm that fixes the frame body; the mounting panel and the supporting arm are mutually connected.

The present invention has the following beneficial effects:

The magnet provided by the present invention allows magnetic hanging of the mobile lighting apparatus that facilitates easy and time-saving fetching and placement. Also, corresponding connecting poles are provided in the present invention to achieve connection with and charging of the mobile lighting apparatus. When the mobile lighting apparatus is required to be charged, charging equipment can be directly connected onto the fame body. When charging is finished, simply remove the charging equipment without the need of moving the mobile lighting apparatus.

### BRIEF DESCRIPTION OF THE DRAWINGS

FIG. 1 is an exploded structural view of the present invention.

FIG. 2 is a sectional structural view of the present invention.

FIG. 3 is a structural view of a negative pole electrically conductive ring of the present invention.

FIG. 4 is a structural view of a positive pole pin of the present invention.

FIG. 5 is a structural view showing the use of the present invention together with a mobile lighting apparatus and a magnetic charger.

FIG. 6 is a structural view showing the mounting of the present invention.

References in the figures:

1—frame body; 101—supporting arm; 102—mounting panel; 103—mounting holes; 104—first through hole; 105—second through holes; 2—positive pole pin; 201—first positive pole contact part; 202—second positive pole contact part; 203—elastic component; 3—negative pole electrically conductive ring; 301—first negative pole contact points; 4—negative pole elastic piece; 5—PCB; 6—magnet; 7—lower cover; 8—negative pole contact piece; 9—mobile lighting apparatus; 901—second negative pole contact point; 902—third positive pole contact point; 10—magnetic charger; 11—fixation body.

### DETAILED DESCRIPTION OF THE INVENTION

Some embodiments of the present invention are further described in detail below. The embodiments are illustrated in the figures. Identical or like references throughout the description and the figures represent identical or like components or components having the same or similar functions. The embodiments described below with reference to the figures should be considered illustrative for the purpose of explaining the technical features of the present invention, and should not be considered as any limitation to the present invention.

In the present invention, it should be noted that directions or positional relationships indicated by terms such as “length”, “width”, “upper”, “lower”, “front”, “rear”, “left”, “right”, “vertical”, “horizontal”, “top”, “bottom” should be understood based on the directions or positional relationships according to the figures, and should also be understood as merely means for simplification for the sake of easier illustration of the present invention. It is not meant or intended to mean that the devices or components concerned should have such specifically described directions, or should be configured or operated according to the specifically described directions, and hence should not be considered as any limitation to the present invention.

Further, terms like “first”, “second” are used for illustrative purpose, and should not be understood as meaning or implying relative importance or as a subtle indication of a quantity of the described technical feature. Therefore, a feature defined by “first” or “second” may comprises by obvious indication or subtle implication, one or more than one of said feature in terms of quantity. In the description, “a plurality of” means a quantity of two or above, unless otherwise specified.

In the present invention, unless otherwise specified, terms such as “install”, “connect”, “communicate” and “fix” should be understood broadly. For example, a fixed connection, a removable connection, or integral formation may be intended. Further, connection may be mechanical or electrical, direct or indirect through a medium, and may be an internal communication between two components or an interactive relationship between two components. A person skilled in this field of art should be able to understand the specific meaning of the terms described in the present invention according to the context of the practical situation described.

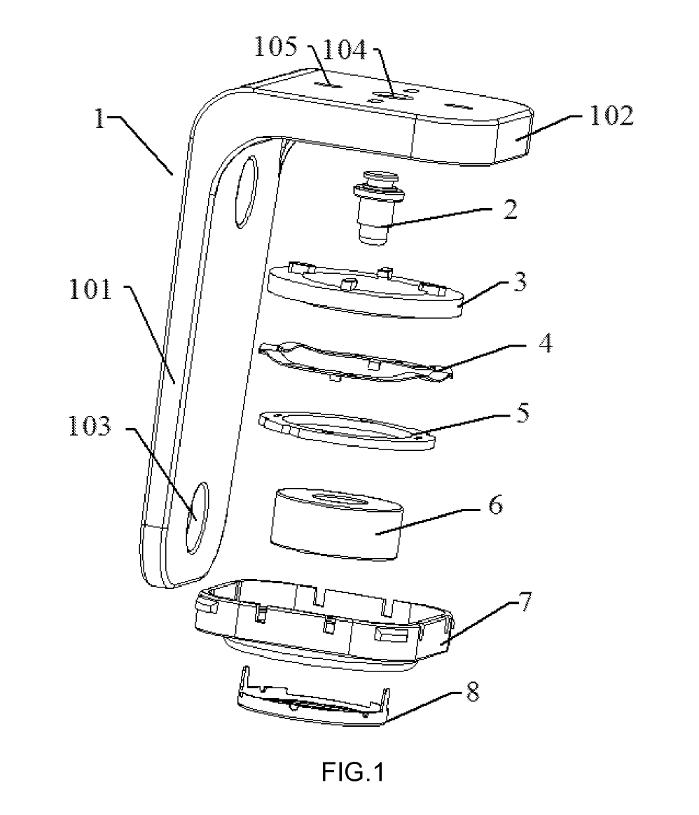

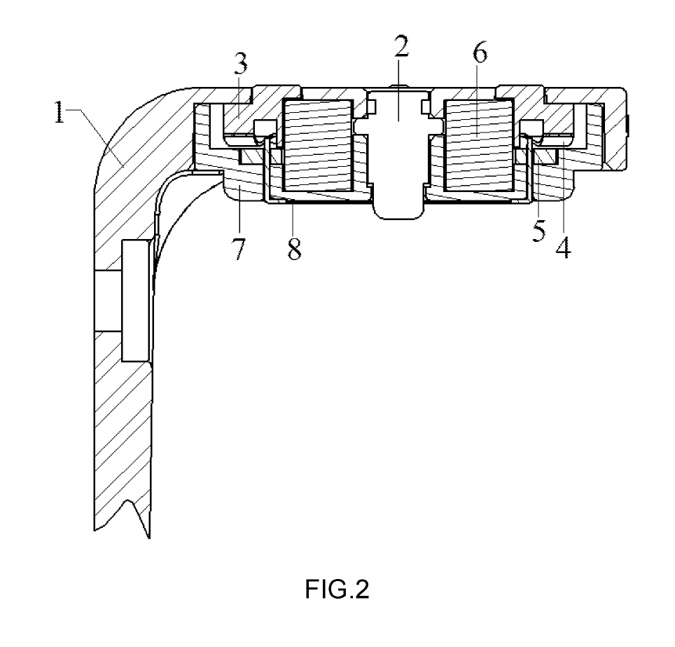

Wit reference to FIGS. 1 and 2, an embodiment of the present invention provides a kind of combined magnetic hanger frame and charger, comprising a frame body 1; a magnet 6 is provided inside the frame body 1; a positive pole pin 2 and negative pole assembly. In the embodiment, the frame body 1 has an inverted L shape comprising a supporting arm 101 and a mounting panel 102; the supporting arm 101 and the mounting panel 102 are formed as an integral structure; mounting holes 103 are provided on the supporting arm 101; the supporting arm 101 is fixed to a fixation body 11 such as a wall through screws passing through the mounting holes, such that the frame body is fixed onto the fixation body 11.

In some other embodiments, the supporting arm 101 and the mounting panel 102 may be two independent parts that are connected to form the frame body 1; the two independent parts are connected by adhesion, buckling or hinging etc. The frame body 1 may also be fixed to the fixation body 11 through other means like hook and loop tapes.

With reference to FIGS. 2 and 4, in an embodiment of the present invention, a cavity that opens at one side is provided inside the mounting panel 102; the magnet 6 is positioned inside the cavity and is fixed inside the cavity by a lower cover 7; the lower cover 7 is fastened with an inner side wall of the cavity of the mounting panel 102; an external side wall of the lower cover 7 facing away from a center of the lower cover is provided with protrusions for fastening; the inner side wall of the cavity of the mounting panel 102 is correspondingly provided with slots that cooperate with the protrusions, such that the lower cover 7 is fastened with the mounting panel 102. The positive pole pine 2 is provided at a center portion of the magnet 6 such that the magnet 6 surrounds the positive pole pin 2; the positive pole pin 2 is fixed by projections provided on the mounting panel 102 and the lower cover 7. The positive pole pin 2 comprises a first positive pole contact part 201 and a second positive pole contact part 202 elastically connected; the second positive pole contact part 202 is defined and positioned inside the first positive pole contact part 201; an elastic component 203 is provided between the first positive pole contact part 201 and the second positive pole contact part 202, such that the elastic component drives the second positive pole contact part 202 to slide with respect to the first positive pole contact part 201. The first positive pole contact part 201 is exposed from one side of the frame body 1; the second positive pole contact part 202 is exposed from another side of the frame body 1 distal from the first positive pole contact part 201 so that the second positive pole contact part 202 can be electrically connected to an external environment. Correspondingly, a first through hole 104 allowing the first positive pole contact part 201 to pass through is provided on the mounting panel 102; another through hole allowing the second positive pole contact part 202 to pass through is provided on the lower cover 7. In the embodiment, the elastic component 203 is an electrically conductive spring. In some other embodiments, the elastic component 203 may be other elastic structures such as electrically conductive elastic metal piece.

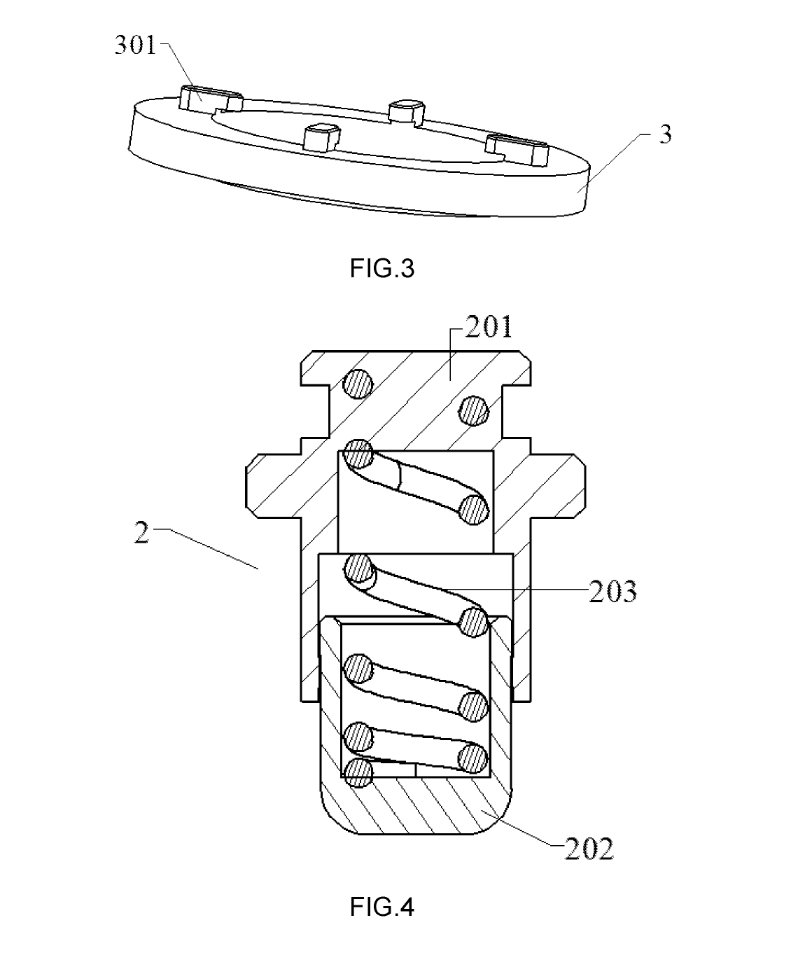

With reference to the embodiment shown in FIGS. 1 and 2, the negative pole assembly comprises a negative pole contact piece 8 provided at one side of the frame body 1, and a negative pole electrically conductive ring 3 provided at another side of the frame body 1 distal from the negative pole contact piece 8; the negative pole contact piece 8 and the negative pole electrically conductive ring 3 are mutually connected. In the embodiment as shown, the negative pole assembly also comprises a negative pole elastic piece 4 provided between the negative pole contact piece 8 and the negative pole electrically conductive ring 3; the negative pole contact piece 8 is also connected with a PCB 5. In the embodiment, the negative pole contact piece 8 is fixed at one side of the lower cover 7 distal from the mounting panel 102; contact pins of the negative pole contact piece 8 extend deep into the cavity of the mounting panel 102 and are welded with the PCB 5; the PCB 5 is positioned inside the cavity. In the embodiment, the negative pole electrically conductive ring 3 is positioned at a side of the cavity distal from the lower cover 7; as shown in FIGS. 2-3, a side of the negative pole electrically conductive ring 3 distal from the lower cover 7 is provided with first negative pole contact points 301; correspondingly, second through holes 105 allowing the first negative pole contact points 301 to pass through are provided on the mounting panel 102; the first negative pole contact points 301 pass through the second through holes 105 and expose from an outer side of the mounting panel 102.

In the embodiment as shown in FIG. 2, the negative pole elastic piece 4 is provided between the negative electrically conductive ring 3 and the negative pole contact piece 8; the negative pole elastic piece 4 is welded with the PCB 5; the negative pole elastic piece 4 is in contact with the negative pole contact piece 8 and the negative pole electrically conductive ring 3 respectively. Due to the resilience of the negative pole elastic piece 4, the negative pole elastic piece 4 can remain in good contact with the negative pole contact piece 8 and the negative pole electrically conductive ring 3 to achieve good electrical conductivity.

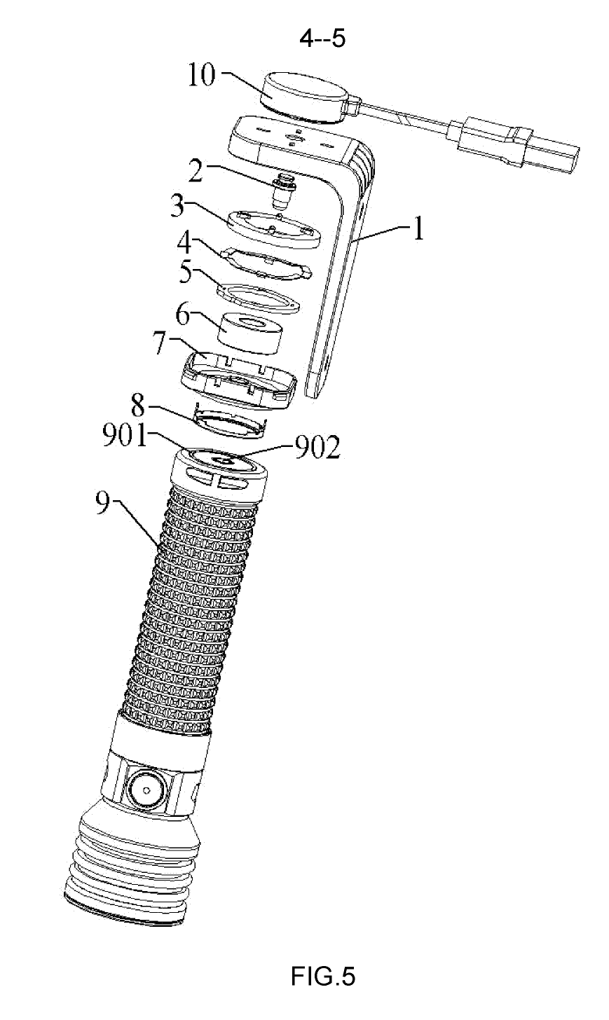

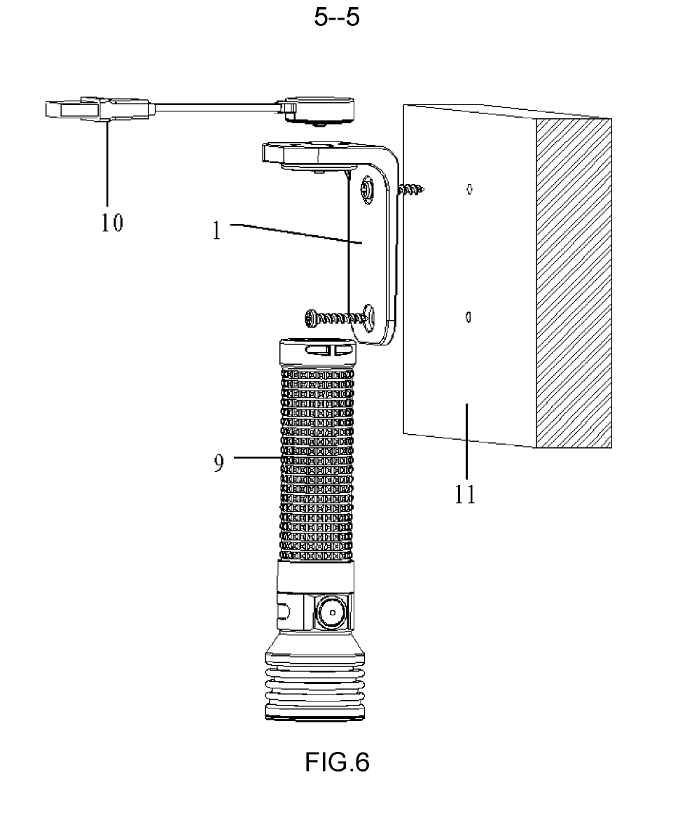

With reference to FIGS. 5-6, during use of the present invention, the frame body 1 is fixed to the fixation body 11; a mobile lighting apparatus may align with the magnet 6 positioned inside the combined magnetic hanger frame and charger and thus magnetically connect with the magnet 6, thereby hanging the mobile lighting apparatus in a fixed position where a user can easily pick up and place back the mobile lighting apparatus. When it is required to charge the mobile lighting apparatus, a magnetic charger 10 is connected to one side of the present invention distal from the mobile lighting apparatus. A positive pole electrical conductive end of the magnetic charger 10 is then in contact with the first positive pole contact part 201 of the present invention, and a negative electrically conductive ring of the magnetic charger 10 is in contact with the first negative pole contact points 301 of the present invention, thereby establishing power transfer between the magnetic charger 10 and the present invention. The mobile lighting apparatus aligns with the present invention and are connected, wherein a third positive pole contact point 902 of the mobile lighting apparatus is in contact with the second positive pole contact part 202 of the present invention. A second negative pole contact point 901 of the mobile lighting apparatus is in contact with the negative pole contact piece 8 of the present invention, thereby establishing power transfer between the present invention and the mobile lighting apparatus. As such, the mobile lighting apparatus is charged. When charging of the mobile lighting apparatus is finished, simply move away the magnetic charger 10 without the need of further placement of the mobile lighting apparatus.

The embodiments described above are only the preferred embodiments of the present invention. General changes or replacements made by a person skilled in this field of art within the scope of the teachings of the present invention should also fall within the scope of protection of the present invention.

What is claimed is:

1. A combined magnetic hanger frame and charger, comprising a frame body (1); a magnet (6) is provided inside the frame body (1); a positive pole pin (2) and a negative pole assembly are mounted on the frame body (1); the negative pole assembly comprises a negative pole contact piece (8) provided at one side of the frame body (1), and a negative pole electrically conductive ring (3) provided at another side of the frame body (1) distal from the negative pole contact piece (8); the negative pole contact piece (8) and the negative pole electrically conductive ring (3) are mutually connected.

2. A combined magnetic hanger frame and charger of claim 1, wherein the negative pole assembly also comprises a negative pole elastic piece (4) provided between the negative pole contact piece (8) and the negative pole electrically conductive ring (3).

3. A combined magnetic hanger frame and charger of claim 1, wherein the negative pole contact piece (8) is also connected with a printed circuit board (PCB) (5); the PCB (5) is connected with the negative pole contact piece (8).

4. A combined magnetic hanger frame and charger of claim 1, wherein a side of the negative pole electrically conductive ring (3) distal from the negative pole contact piece (8) is provided with first negative pole contact points (301); the first negative pole contact points (301) are exposed from an outer side of the frame body (1).

5. A combined magnetic hanger frame and charger of claim 1, wherein the positive pole pin (2) comprises a first positive pole contact part (201) and a second positive pole contact part (202) elastically connected; the first positive pole contact part (201) is exposed from one side of the frame body (1); the second positive pole contact part (202) is exposed from another side of the frame body (1) distal from the first positive pole contact part (201).

6. A combined magnetic hanger frame and charger of claim 5, wherein an elastic component (203) is provided between the first positive pole contact part (201) and the second positive pole contact part (202).

7. A combined magnetic hanger frame and charger of claim 1, wherein the magnet (6) surrounds the positive pole pin (2); the magnet (6) is fixed inside the frame body (1) by a lower cover (7).

8. A combined magnetic hanger frame and charger of claim 1, wherein the frame body (1) has an inverted L shape.

9. A combined magnetic hanger frame and charger of claim 1, wherein the frame body (1) comprises a mounting panel (102) and a supporting arm (101) that fixes the frame body (1); the mounting panel (102) and the supporting arm (101) are mutually connected.
